(19) United States
(12) Patent Application Publication
(10) Pub. No.: US 2017/0216128 A1
(43) Pub. Date: Aug. 3, 2017

(54) Skin Scraper

(71) Applicant: Dirk WEHLMANN, Wiesbaden (DE)

(72) Inventor: Dirk Wehlmann, Wiesbaden (DE)

(21) Appl. No.: 15/310,127

(22) PCT Filed: May 8, 2015
(86) PCT No.: PCT/EP2015/060266

§ 371 Date: Nov. 10, 2016

(30) Foreign Application Priority Data
May 12, 2014 (DE) 10 2014 006 742.4

(51) Int. Cl. A61H 7/00; A47K 7/02

(52) U.S. Cl. CPC A61H 7/003; A47K 7/028; A61H 2201/0153; A61H 2201/0192

(57) ABSTRACT

A skin scraper is described which comprises a blade which is made of non-corroding metals or alloys or plastic which has two long sides (a) and (b) wherein the side (a) has a concave curvature, the other long side (b) is straight, curved or structured, as well a narrow side (c), which has at its edges one or more bulges, and the side (d), which is opposite to the side (c), is linked to a handle (e), and the blade has on one or both surfaces parallel to the sides (a) and (b) one or two grooves which have an outflow (h) at the side (c). The skin scraper is in particular useful for cleaning, depth purification, massage of the skin, removing of sweat water and improvement of the respiratory function of the skin.

### FIELD OF THE INVENTION

The invention relates to a skin scraper and its use for massage, treatment and cleaning of human skin, in particular for use in a sauna. Thus, in addition to the respiratory function, the function of detoxification and the function of purging of the skin for the body are supported.

### BACKGROUND OF THE INVENTION

Skin scrapers for treating the skin have long been known and are also described in a number of patents, patent applications and the like.

So in AT 113822 a device is described which is used for massaging and cleaning of the skin from impurities such as blackheads etc. It consists of a plate wherein the grinding plane i.e. the plane which is guided over the skin forms a right angle with the plate surface.

In U.S. Pat. No. 1,965,861 a device for treating the skin is described consisting of a convex vaulted plate on the center of which a stick with a handle is attached which resembles in appearance a rammer such as is used to mash potatoes. The plate is vaulted concave and has more or less rounded sides wherein the opposite narrower sides can be convex or concave, the opposite longer sides extend relatively straight. The device is especially suitable for treating and cleaning of the facial skin, in particular for removing dirt, face cream and the like and for massaging.

In U.S. Pat. No. 4,438,767 a scraper for the treatment of the skin is described which serves for scraping off of dead skin tissue or dead cells. It essentially consists of a circular flat disc having an opening which allows that when one moves a thumb and a finger of each side towards each other and thus can grip the disc firmly. The outer edge of the disc is thin and formed as a fine edge. The device is particularly intended for the treatment of acne and dry skin. The skin is scraped with the outward circular edges.

In U.S. 2009/0177210 A1 a device is described for the treatment of the skin which comprises a part which is formed as a handle. In a part distal thereto an element is installed which is convex to the outside and is intended for coating the skin. In this way skin cells and other materials are removed from the skin.

In DE 20 2010 001 307 U1 a massage device is described which is produced from ebonite, oak, beech or birch which has preferably a length of about 10 to 20 cm and a width of 6 to 10 cm and has a cup-like depression. With this device dead skin particles can be removed.

In U.S. design 155,773 a scimitar-like design is described which is connected with a handle and is intended to be used as a facial and body scraper.

In U.S. patent application 2005/0049534 A1 a massage device is described which is only intended for massaging; it is not suitable for a use in a sauna to collect sweat water.

In the publication “Zur Kunde der Alterthiimer des Menschengeschlechts,” Illustrierte Zeitschrift für Länder and Völkerkunde, Vol. 9, 1866, pages 15-19, different devices of the Stone Age time are described which can be used as weapons but also as a scratcher and scraper. Skin scrapers for the use in a sauna having a structure as taught by the invention however cannot be taken from this publication.

In CN 201 9555 499 Y a skin scraper is described which has in its entirety the form of a concave formed half hose. A skin scraper having the special structural elements of a skin scraper according to the invention however cannot be taken from this Chinese patent application.

In CN 20162020140 U a scraper is described where the scraping part is put vertically on a rod-like shaped stick and thus has a completely different structure from that taught by the invention.

CN 203 244 565 U describes a scraper which has a completely different structure than taught by the invention.

CN 1 126 069 A describes scraper which has, as can be seen from the figures, no similarity with the skin scrapers according to the invention.

In JP3129905 U devices are described which shall serve for combining and treating e.g. hands, besides many differences compared with the invention these devices do not have a groove to take up sweat water.

KR 2013 99113087 A describes scrapers which differ essentially from the invention as can be seen by one look at the figures. There are, inter alia, no grooves and no different bulges are to be found.

Also the scrapers disclosed in TW M474510U differ essentially from the invention and do not have grooves for the uptake of sweat water, nor any different bulges and no handle.

Although quite a lot of devices such as skin scrapers for the treatment of the skin are known there is still a need for further developed devices for massage, treatment and in particular for cleaning and purging the skin, especially in the sauna.

### Object of the Invention

The object of the invention is therefore to provide a skin scraper which is easily produced and which may be applied, in particular in a sauna, effectively and conveniently by the sauna visitors or a semiskilled service provider.

Another object of the invention is to further provide a gentle and effective massage, to improve blood circulation and to make it possible to handle difficult locations which one should approach with care in confined spaces.

Another object of the invention is to remove by the scraping procedure over the skin sweat water which is enriched with impurities, also from deeper layers, and skin elements, during the sauna session and thus to bring relief to the sauna visitor on account of a deep pore purification.

A further object of the invention is to provide a skin scraper with which it is possible to accumulate during the treatment of the skin sweat water, excreta, skin impurities, dead cells and the like on the skin scraper and to conduct to a further analysis or investigation.

### BRIEF SUMMARY OF THE INVENTION

### Solution

This object is solved by a skin scraper characterized in that it has a blade made of non-corroding metals or alloys or plastic which has two long sides (a) and (b) wherein the side (a) has a concave curvature, the other long side (b) is straight, curved or structured, as well a narrow side (c), which has at its edges one or more bulges, and the side (d), which is opposite to the side (c), is linked to a handle (e), and the (c) blade has on one or both surfaces parallel to the sides (a) and (b) one or two grooves which have an outflow (h) at the side (c).

### BRIEF DESCRIPTION OF THE SEVERAL VIEWS OF THE DRAWING

FIG. 1 is a plan view of a skin scraper in accordance with an embodiment of the invention.

FIG. 2 is a plan view of a skin scraper in accordance with a second embodiment of the invention.

FIG. 3 illustrates a use and function of the skin scraper.

### DETAILED DESCRIPTION OF THE PREFERRED EMBODIMENT(S)

The bulges have preferentially a round, in particular circular or arc-shaped boundary with preferentially different radii of curvature which differ preferentially at least 20%.

The borders of the sides (a), (b) and (c) are rounded or tapered at the outer border.

At the transition location between blade and handle a finger guard (f) may be mounted, which is intended to protect and support a thumb and a finger e.g. the index finger or the middle finger.

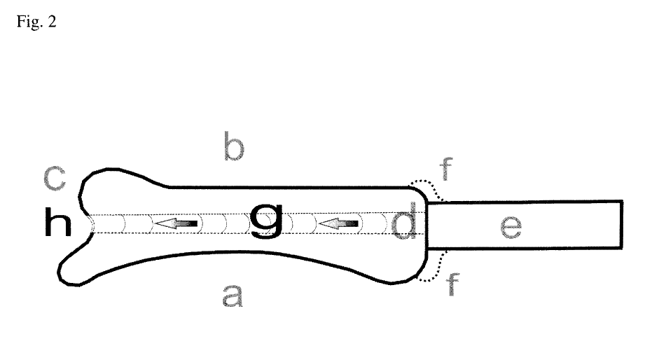

In FIG. 2 the skin scraper is presented with a single groove, the arrows show the outfeed direction to the discharge (h).

The length of the sides (a) and (b) can vary between wide limits, e.g. 5 to 30 cm, the width e.g. 2 to 5 cm. Other dimensions are possible.

The blade is preferably flat or vaulted and has preferably a thickness of 1 to 5 mm.

As material for the blades stainless metals and alloys, steel among other things, but also plastics such as Plexiglas, horn, ceramics and so on are suitable.

The device according to the invention is particularly suitable for massaging, treating, cleaning and purification of the skin, in particular for use during the stay in a sauna.

A particular type of use is collecting of impurities, also from deeper layers of the skin, together with enriched sweat water and possibly present skin residues, dead cells, and the like and feeding these collected materials for analysis or investigation purposes.

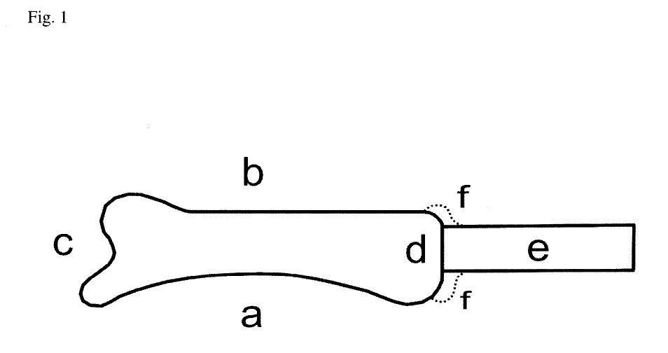

The production of a skin scraper according to the invention is simple and can be performed manually or mechanically, in particular automatically. Thus e.g. a body can be worked out from a metal sheet or a metal strip by punching, cutting or sawing which has the form according FIG. 1. The edges of the sides (a), (b) and (c) may be rounded or tapered by filing or grinding.

The blade is connected at the side with a handle directly or through the interposition of a stem of appropriate length e.g. 10 to 30 cm. It is also possible to make the stem as a telescope; thus one can vary the length and to reach closer or more distant locations of the body comfortably while lying in the sauna.

### Use of the invention

The use of the device is simple. The user sweeps the skin scraper with pressure, preferentially under an acute angle, e.g. 20° over the skin surfaces. By varying the applied pressure it is possible besides a simple surface effect such as stripping of moisture or loose particles on the skin to achieve a depth effect. This is done by scraping and pressing flatly the sebaceous glands and the sweat pores of the skin which is preheated in the sauna.

With the bulges it is possible to carefully reach sensitive locations and to leave out vulnerable places.

Also simple is the collecting of liquid enriched with impurities, scraped particles which accumulate during the treatment of the skin in one or more grooves which are on the scraper and to give them from there into a collecting vessel and to then be taken for analysis and examination purposes.

The pore deep purification brings the sauna visitor a considerable relief and an increase of well-being. In addition the skin respiration and further perspiration are facilitated and fostered and thus the effect of a sauna visit improved.

The invention is further illustrated by the following examples.

### Example 1: Preparation

A molded article is punched from a 3 mm stainless steel sheet with a length of 25 cm and a width of 5 cm, a concave side (a) and a straight side (b) and two circular bulges. On side (d) at the handle (e) two wooden grips are placed. Centrally a longitudinal groove of each 0.5 mm depth is worked out above and below.

### Example 2: Use

The in a sauna heated and moistened skin is scraped with a scraper according to example 1 with an angle of 20° and with a variable pressure. The sweat water which is enriched with impurities is collected in the central groove and via the outlet (h) given in a separate vessel. The collected liquid is analytically examined for its composition.

The invention brings significant advantages when used to treat the skin. Thus, also a pretreatment can take place before going into the sauna and thus to prepare advantageously the skin. The treatment is very simple and can easily be carried out by the sauna visitor sitting or lying. Theoretically all parts of the body are reachable, also possible is the implementation by a trained specialist.

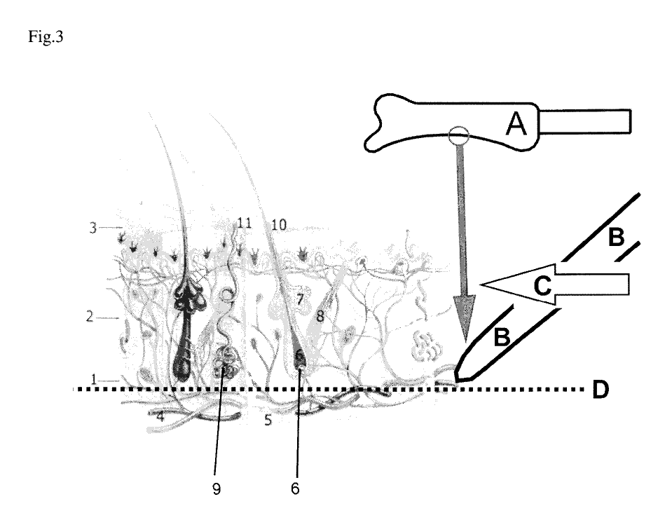

The function of the invention is further illustrated with reference to FIG. 3.

### Explanation of the Process

The blade with the edge B of the skin scraper A is surface pressed and pushed along the skin in direction C. This takes place approximately up to the press depth D so that the sweat and the impurities below in the sweat glands are pressed to the surface via the sweat exit (11). On the other side the sebaceous glands (7) are pressed over the papilla's (6) and the impurities are brought out via the hair exit (10). These are then taken up with the skin scraper A on the surface and led away.

The application can be integrated into different workflows. For an ideal preparation undertake sportive activity and copious take up of liquids before the sauna visit. For a posttreatment use an oxygen bath or also the application of an appropriate moisturizer cream.

### LEGEND

a concave long side
b long side opposite to side a
c small side
d small side opposite to side c
e handle
f finger protection
g groove
h discharge
A skin scraper (invention)
B blade (in cross section to the skin surface)
C direction of scraping
D possible press depth
1 connective tissue
2 dermis
3 epidermis
4 blood vessels
5 fat cells
6 hair papilla
7 sebaceous
8 hair raising muscle
9 sweat gland
10 hair exit
11 sweat exit (pore)

1. A skin scraper characterized in that it has a blade made of non-corroding metals or alloys or plastic which has
(a) first and second long sides, wherein the first long side has a concave curvature, the second long side is straight, curved or structured,
(b) a narrow side which has at its edges one or more bulges, and
(c) a fourth side opposite to the narrow side, the fourth side is linked to a handle, and the blade has on one or both surfaces parallel to the first and second sides one or two grooves which have an outflow at the narrow side.

2. The skin scraper according to claim 1, characterized in that the bulges have a round boundary.

3. The skin scraper according to claim 2, characterized in that the bulges have different radii of curvature.

4. The skin scraper according to claim 3, characterized in that the radii of curvature differ by at least 20%.

5. The skin scraper according to claim 1, characterized in that borders of the first, second and narrow sides are rounded or tapered at an outer border.

6. The skin scraper according to claim 1, characterized in that at a transition location between the blade and the handle a finger guard is mounted to protect and support a thumb and a finger.

7. The skin scraper according to claim 1, characterized in that the blade is one or two sided.

8. The skin scraper according to claim 1, characterized in that the blade is flat and has a thickness of 1 to 5 mm.

9. The skin scraper according to claim 1, characterized in that the blade is curved.

10. The skin scraper according to claim 1, characterized in that the blade is connected to the handle by aid of a stick.

11. The skin scraper according to claim 10, characterized in that the stick is telescopic.

12. A method of using the skin scraper according to claim 1, comprising a step of scraping skin with the skin scraper for massage, treating cleaning and purification of the skin.

13. A method of using the skin scraper according to claim 1, comprising steps of scraping skin with the skin scraper for collecting contaminated sweat water and liquid or solid excreta which may contain skin residues, impurities, dead cells and the like and subjecting these substances to analysis or examination.

14. The skin scraper according to claim 2, characterized in that the bulges have a circular boundary.

15. The skin scraper according to claim 7, wherein one or both sides of the blade are concentric with and/or parallel to grooves in the first and second sides that join the narrow side and include a discharge.

16. The method of claim 12, wherein the scraping step is for the separation of enriched sweat water during a stay in a sauna.

17. The method of claim 13 using the skin scraper according to claim 7.

18. The skin scraper according to claim 1, characterized in that borders of the first, second and narrow sides are rounded or tapered at an outer border and at a transition location between the blade and the handle a finger guard is mounted to protect and support a thumb and a finger.

19. The skin scraper according to claim 18, characterized in that the blade is connected to the handle by aid of a telescopic stick.

20. The skin scraper according to claim 19, characterized in that the blade is curved.
